(19) United States
(12) Patent Application Publication
(10) Pub. No.: US 2015/0280285 A1
(43) Pub. Date: Oct. 1, 2015

(54) ACCUMULATOR SYSTEM

(71) Applicants: SANYO ELECTRIC CO., LTD., Osaka (JP); PANASONIC CORPORATION, Osaka (JP)

(72) Inventors: Kenji Fujita, Hyogo (JP); Toshihiro Sakatani, Hyogo (JP); Hiromasa Sugii, Hyogo (JP); Makoto Ochi, Hyogo (JP); Ryuji Kawase, Hyogo (JP); Etsuko Ogasawara, Aichi (JP); Kazuhiro Sugie, Shizuoka (JP)

(21) Appl. No.: 14/432,216

(22) PCT Filed: Oct. 29, 2013
(86) PCT No.: PCT/JP2013/006384

§ 371 Date: Mar. 30, 2015

(30) Foreign Application Priority Data
Oct. 30, 2012 (JP) 2012-239416

(51) Int. Cl. H01M 10/06; H01M 10/26; H01M 10/30

(52) U.S. Cl. CPC H01M 10/06; H01M 10/30; H01M 10/26; H01M 2300/0014; H01M 2220/20

(57) ABSTRACT

In the storage battery system, from the same temperature and the same voltage as both batteries a decrease per day of an open-circuit voltage of the lead-acid storage battery by a self-discharge is ΔV1(V/day) and a decrease per day of an open-circuit voltage of the sub-battery by a self-discharge is ΔV2(V/day), and a relation of ΔV1≧ΔV2 is satisfied. The sub-battery is a nickel hydride storage battery.

### TECHNICAL FIELD

The present invention is related to an accumulator system, namely a storage battery system where a lead-acid storage battery and a sub-battery are connected in parallel.

### BACKGROUND ART

A lead-acid storage battery has a comparatively stable performance in a large current discharge during a short time or a shallow depth of a discharge, and a low cost. However, unless a full charge state is maintained, the lead-acid storage battery has characteristics that its life is shortened. At present, the lead-acid storage battery is largely used as a storage battery for the idle stop function (the idle reduction function) or the regenerative power generation. In such a usage, an alternator of a vehicle is stopped during a discharge from the lead-acid storage battery, and fuel efficiency is improved by decreasing engine load. Further, regenerative power is recovered through regenerative braking at deceleration in the vehicle.

However, in the case where the lead-acid storage battery is used in the vehicle having the idle stop function or the regenerative braking function in which energy at deceleration is recovered as electric power energy, as the lead-acid storage battery is frequently discharged, compared with usage for general start, and the lead-acid storage battery is early degraded. When the lead-acid storage battery is replaced with a nickel hydride storage battery or a lithium ion secondary battery, such a problem can be solved, but cost is remarkably increased.

Therefore, a storage battery system where a nickel hydride storage battery or a lithium ion secondary battery is connected in parallel to the lead-acid storage battery, is considered (refer to patent literature 1 described below).

### CITATION LIST

### Patent Literature

Patent Literature 1: Japanese Laid-Open Patent Publication No. 2007-46508

### SUMMARY OF THE INVENTION

However, the lead-acid storage battery and the sub-battery are different in self-discharge characteristics. For example, in the storage battery system for a vehicle, when the storage battery system having the lead-acid storage battery and the sub-battery is intermittently used, the voltage difference between the lead-acid storage battery and the sub-battery occurs at the time of using again due to the difference of self-discharge characteristics between the lead-acid storage battery and the sub-battery at non-use time. At this time, when a voltage decrease of the sub-battery is larger than that of the lead-acid storage battery, namely self-discharge of the sub-charge is larger than that of the lead-acid storage battery, a charging current flows from the lead-acid storage battery to the sub-battery, and a charging state of the lead-acid storage battery is decreased, and then there is a problem that durability of the lead-acid storage battery is decreased.

One non-limiting and explanatory embodiment provides a storage battery system where it is difficult that a charging current flows from the lead-acid storage battery to the sub-battery, and durability of the lead-acid storage battery is improved in the storage battery system where the lead-acid storage battery and the sub-battery are connected in parallel.

A storage battery system of the present disclosure comprises a lead-acid storage battery, and a sub-battery connected to the lead-acid storage battery in parallel, and from the same temperature and the same voltage as both batteries a decrease per day of an open-circuit voltage of the lead-acid storage battery by a self-discharge is Δ V1(V/day) and a decrease per day of an open-circuit voltage of the sub-battery by a self-discharge is ΔV2(V/day), and a relation of ΔV1≧ΔV2 is satisfied.

Even though the open-circuit voltages of the lead-acid storage battery and the sub-battery is the same temperature and the same voltage at first, a decrease per day Δ V1 of an open-circuit voltage of the lead-acid storage battery by a self-discharge is larger than a decrease per day ΔV2 of an open-circuit voltage of the sub-battery by a self-discharge, namely a relation of ΔV1≧ΔV2 is satisfied. Therefore, the lead-acid storage battery is charged from the sub-battery, but the sub-battery is not charged from the lead-acid storage battery. According to the storage battery system of the present disclosure, as it is suppressed that the sub-battery is charged from the lead-acid storage battery, the durability of the lead-acid storage battery is not decreased, and it is possible to provide the storage battery system highly functionalized by the lead-acid storage battery.

### BRIEF DESCRIPTION OF DRAWINGS

FIG. 1 is a longitudinal sectional view of a nickel hydride storage battery used in various examples.

FIG. 2 is a view showing charging and discharging in a storage battery system where a lead-acid storage battery and a nickel hydride storage battery are connected in parallel.

FIG. 3 is a schematic circuit diagram of a power supply system for a vehicle.

### DESCRIPTION OF EMBODIMENTS

Embodiments for carrying out the invention will now be described in detail based on examples. It is to be understood, however, that the following embodiments are intended as an illustrative example for embodying the technical concepts of the invention, and are not intended to limit the invention to the embodiments. The invention can be equally applied to various modifications without departing from the technical concepts set forth in the claims.

### <Lead-Acid Storage Battery>

The lead-acid storage battery used in each of examples, or comparative examples which meets the following performances under the test condition provided by STANDARD OF BATTERY ASSOCIATION OF JAPAN (SBA S 0101) are used.
Capacity per 5 hours: 48 Ah
Rated cold cranking current: 320 A
Acceptability of charging: 6.0 A

### <Nickel Hydride Storage Battery>

A nickel positive electrode was used such that pores of the porous nickel sintered substrate were filled with the positive electrode active material including mainly nickel hydroxide, and either zinc hydroxide or cobalt hydroxide. The porous nickel sintered substrate was prepared in the following way.

Methyl cellulose (MC) as a thickener, polymeric hollow microspheres having a pore size of, for example, 60 μm, and water were mixed with nickel (Ni) powder, and the whole was kneaded to prepare a nickel slurry. Next, the nickel slurry was applied onto both sides of a punching metal made from a nickel coated steel plate, and then the plate was heated in a reducing atmosphere at 1000° C. to remove the coated thickener and polymeric hollow microspheres and to sinter the nickel powder to each other. The porous nickel sintered substrate was obtained. The porous nickel sintered substrate has a porosity of about 85% in measurement by a mercury intrusion porosimeter of a gravimetric method (PASCAL 140 made by Fisons Instruments Inc.).

The obtained porous nickel sintered substrate was immersed in the impregnating solution prepared by mixing nickel nitrate (Ni(NO₃)₂), and zinc nitrate (Zn(NO₃)₂) or cobalt nitrate (Co(NO₃)₂) impregnating solutions were held within pores of the porous nickel sintered substrate, and then it was dried. Next, this porous nickel sintered substrate was immersed in the alkaline treatment solution of an aqueous sodium hydroxide (NaOH) solution having a specific gravity of 1.3 as the alkaline treatment. Nickel nitrate, and zinc nitrate or cobalt nitrate were converted into nickel hydroxide (Ni(OH)₂), and zinc hydroxide (Zn(OH)₂) or cobalt hydroxide (Co(OH)₂). After this, the substrate was sufficiently washed with water to remove the alkaline solution, and then dried.

Such a series of positive electrode active material filling operations included that the porous nickel sintered substrate was immersed in the impregnating solution and dried, and was immersed in the alkaline treatment solution and washed with water, and dried. Such a series of positive electrode active material filling operations were repeated experimentally predetermined times to fill each of the porous nickel sintered substrate with an experimentally predetermined amount of the positive electrode active material.

A negative electrode core substrate made from a punching metal (made from a nickel coated steel plate) was filled with the negative electrode active material slurry to prepare the hydrogen storage alloy negative electrode. For example, lanthanum (La), neodymium (Nd), magnesium (Mg), nickel (Ni), and aluminum (Al) were mixed in the molar ratio of the following chemical formula, and the mixture was placed in a high-frequency induction heater to be melted, and then rapidly cooled to prepare a hydrogen storage alloy ingot having a composition of La_{0.4}Nd_{0.5}Mg_{0.1}Ni_{3.5} Al_{0.2}. The obtained hydrogen storage alloy ingot was heat-treated at a temperature by 30° C. lower than the melting point of the hydrogen storage alloy for, for example, 10 hours.

Next, the obtained hydrogen storage alloy ingot was roughly pulverized, and mechanically pulverized in an inert gas atmosphere, and particles of sizes between 400 mesh and 200 mesh were sifted out, and then the powder of the hydrogen storage alloy was obtained. Here, this powder was analyzed by a laser diffraction/scattering particle size analyzer to determine its particle size distribution. As a result, an average particle diameter was 25 μm, which indicated 50% of mass integral (D50). This was the powder of the hydrogen storage alloy.

Then, 100 parts by mass of the obtained hydrogen storage alloy powder was mixed with 0.5 part by mass of styrene butadiene rubber (SBR) as a water-insoluble polymer binder, 0.03 part by mass of carboxymethyl cellulose (CMC) as a thicker, and an appropriate amount of pure water, and the whole was kneaded to prepare a negative electrode active material slurry. Next, the obtained negative electrode active material slurry was applied to both sides of a negative electrode core substrate made from a punching metal (made from a nickel coated steel plate). Then, the substrate was dried at 100° C. and rolled so as to have a predetermined packing density, and cut into a predetermined size to prepare the hydrogen storage alloy negative electrode.

The electrolyte was a mixture of sodium hydroxide (NaOH), potassium hydroxide (KOH), lithium hydroxide (LiOH), and adjusted at the predetermined mole ratio, alkali concentration which is shown in Table 1 described below. Further, sodium tungstate as the tungsten compound was added at the predetermined amount in terms of tungsten to the total mass of the alkaline electrolyte shown in Table 1 described below.

The separator was made of the polyolefin-based synthetic resin nonwoven fabric of 55 g/cm². The separator was interposed between the above positive and negative electrode substrates, and the plates were wound in a spiral form, and the spiral electrode assembly was prepared. At this time, at least one surface of the separator was carried out the sulfonation treatment or has ammonia-adsorbing fabric, and then has ammonia-adsorbing performance.

A positive electrode current collector was connected by welding to the end portion of the positive electrode core substrate exposed at the top portion of the obtained spiral electrode assembly, and the negative electrode core substrate was exposed as the negative electrode core substrate tab portion at the lower portion thereof. After this, a negative electrode current collector was connected by welding to the hydrogen storage alloy core substrate exposed at the bottom portion. This spiral electrode assembly was inserted into the outer can, and the negative electrode current collector was connected by welding to the can bottom portion, and the above electrolyte was injected into the outer can. After that, the positive electrode current collector was connected by welding to a sealing member, and a sealing portion was caulked and sealed, and six kinds of the cylindrical nickel hydride storage batteries having the capacity of 6.0 Ah were obtained.

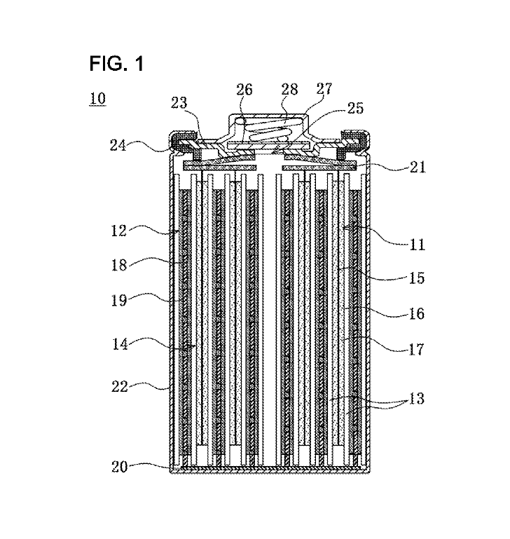

The common concrete configuration of six kinds of cylindrical nickel hydride storage batteries prepared in the above way is explained in the following by using FIG. 1. Each of these nickel hydride storage batteries 10 has the spiral electrode assembly 14 in which the nickel positive electrode 11 and the hydrogen storage alloy negative electrode 12 prepared in the above were wound in an insulating state to each other by interposing the separator 13 therebetween.

In the nickel positive electrode 11, the positive electrode active material 17 mainly including the nickel hydroxide with either zinc hydroxide or cobalt hydroxide added was filled within pores of the porous nickel sintered body 16 formed onto both sides of the punching metal made from a nickel coated steel plate as the positive electrode core substrate 15. In the hydrogen storage alloy negative electrode 12, the negative electrode mixture layers 19 having the powder of the hydrogen storage alloy as the negative electrode active material on both sides of the negative electrode core substrate 18 of the punching metal made from the nickel coated steel plate, were formed.

The lower portion of the spiral electrode assembly 14 is connected by resistance welding to the negative electrode current collector 20, and the top portion of the spiral electrode assembly 14 was connected by resistance welding to the positive electrode current collector 21. The spiral electrode assembly 14 was inserted into the metal outer can 22 which was made of the nickel coated iron and had a tube shape including the bottom portion. Then, the negative electrode current collector 20 was connected by spot welding to the inner side of the bottom portion of the metal outer can 22.

The sealing member 23 made of a nickel coated iron was disposed at the opening end side of the metal outer can 22 in a state that the sealing member 23 and the metal outer can 22 were insulated through the gasket 24, and the open end edge of the metal outer can 22 was caulked. The positive electrode current collector 21 was coupled by welding and electrically connected to the sealing member 23. The opening portion 25 was provided at the center portion of the positive electrode current collector 21, and a valve element 26 was disposed at the opening portion 25 such that the valve element 26 covered the opening portion 25.

A positive electrode cap 27 was provided so as to cover the periphery of the opening portion 25 on the upper surface of the sealing member 23, and to be separated by a fixed distance from the valve element 26. A gas vent hole (not shown in the figures) was properly provided at the positive electrode cap 27. A spring member 28 was provided between the inner surface of the positive electrode cap 27 and the valve element 26, and the valve element 26 was pushed by the spring member 28 so as to cover the opening portion 25 of the sealing member 23. This valve element 26 had a function of a safety valve in which inner pressure can be released at the time of increasing the inner pressure of the metal outer can 22.

After six kinds of the cylindrical nickel hydride storage batteries were charged with a charging current of 1 lt (=6 A) till 120% of SOC (State Of Charge: charging depth) in a constant temperature oven at 25° C., those were left and rested for an hour. Next, after 24 hour leaving in a constant temperature oven at 60° C., those were discharged with a current of 1 lt by the voltage 0.9 V. This charging and discharging cycle was one cycle, and the charging and discharging cycles were repeated in two cycles, and then the batteries were activated. Next, in each of the activated six kinds of the cylindrical nickel hydride storage batteries, ten cells were connected in series, and then the six kinds of storage battery modules A to F shown in Table 1 described below were prepared.

TABLE 1

| | electrolyte | | | | |
|---|---|---|---|---|---|
| | concen- | | | | |
| | tration | KOH | NaOH | LiOH | W amount * |
| storage | 7.0 mol/L | 7.0 mol/L | no | no | no |
| battery | | | | | |
| module A | | | | | |
| storage | 7.0 mol/L | 6.8 mol/L | no | 0.2 mol/L | no |
| battery | | | | | |
| module B | | | | | |
| storage | 7.0 mol/L | 6.8 mol/L | no | 0.2 mol/L | 20 mg |
| battery | | | | | |
| module C | | | | | |
| storage | 7.0 mol/L | 6.8 mol/L | no | 0.2 mol/L | 50 mg |
| battery | | | | | |
| module D | | | | | |
| storage | 7.0 mol/L | 5.8 mol/L | 1.0 mol/L | 0.2 mol/L | 50 mg |
| battery | | | | | |
| module E | | | | | |
| storage | 7.0 mol/L | 2.8 mol/L | 4.0 mol/L | 0.2 mol/L | 50 mg |
| battery | | | | | |
| module F | | | | | |

* per 1 g of electrolyte

### <Storage Battery System>

After the following treatments, the above lead-acid storage battery and the six kinds of the storage battery modules A to F were connected in parallel respectively.

Under the charging condition provided by STANDARD OF BATTERY ASSOCIATION OF JAPAN (SBA S 0101), namely the lead-acid storage battery was charged with a charging current of 0.2 lt (=9.6 A) until the terminal voltage during charging in 15 minutes time intervals, or the electrolyte density by temperature correction shows a constant value in the 3 consecutive measurements, and after 24 hour leaving in a normal temperature, the voltage of the open circuit is measured as an initial voltage.

After the storage battery modules A to F were respectively charged with a constant charging current of 1 lt till 110% of the battery capacity, those were discharged with a constant current of 1 lt by an experimentally predetermined SOC. And after 24 hour leaving in a normal temperature, open-circuit voltages of them were measured and obtained as initial voltages. Here, the experimentally predetermined SOC means the following. The relation between the open-circuit voltage after 24 hour leaving in a normal temperature and SOC in the storage battery modules of the nickel hydride storage battery was obtained in advance, and when the open-circuit voltage after 24 hour leaving in a normal temperature approximately coincides with the initial voltage of the lead-acid storage battery, a corresponding SOC shows the experimentally predetermined SOC.

### <Evaluation of Decrease in Open-Circuit Voltage by Leaving>

In the lead-acid storage battery and the storage battery modules of which the initial voltages were adjusted by the above ways, the open-circuit voltages during 2 day separately leaving at 60° C. thereof, were measured at the time after each day, and thus ΔV1(V/day) of the lead-acid storage battery and ΔV2(V/day) of the storage battery module as decreases per day of open-circuit voltage were obtained from the absolute value of the slope by linear approximation of the leaving times and the open-circuit voltages. Its result is shown in Table 2.

TABLE 2

| | open-circuit voltage | | | | |
|---|---|---|---|---|---|
| | initial | after one | after two | ΔV1 | ΔV2 |
| title | time(V) | day (V) | days (V) | (V/day) | (V/day) |
| lead-acid storage | 12.821 | 12.772 | 12.710 | 0.055 | — |
| battery | | | | | |
| storage battery | 12.824 | 12.730 | 12.610 | — | 0.107 |
| module A | | | | | |
| storage battery | 12.827 | 12.790 | 12.755 | — | 0.036 |
| module B | | | | | |
| storage battery | 12.825 | 12.802 | 12.767 | — | 0.029 |
| module C | | | | | |
| storage battery | 12.822 | 12.800 | 12.780 | — | 0.021 |
| module D | | | | | |
| storage battery | 12.820 | 12.810 | 12.795 | — | 0.013 |
| module E | | | | | |
| storage battery | 12.819 | 12.813 | 12.801 | — | 0.009 |
| module F | | | | | |

### <Evaluation of Durability>

The lead-acid storage battery and each of the storage battery modules A to F of which the initial voltages were adjusted by the above ways, were connected in parallel after confirming that the difference in the open-circuit voltages therebetween was 0.1 V or less. Then, the storage battery systems of experimental examples were prepared.

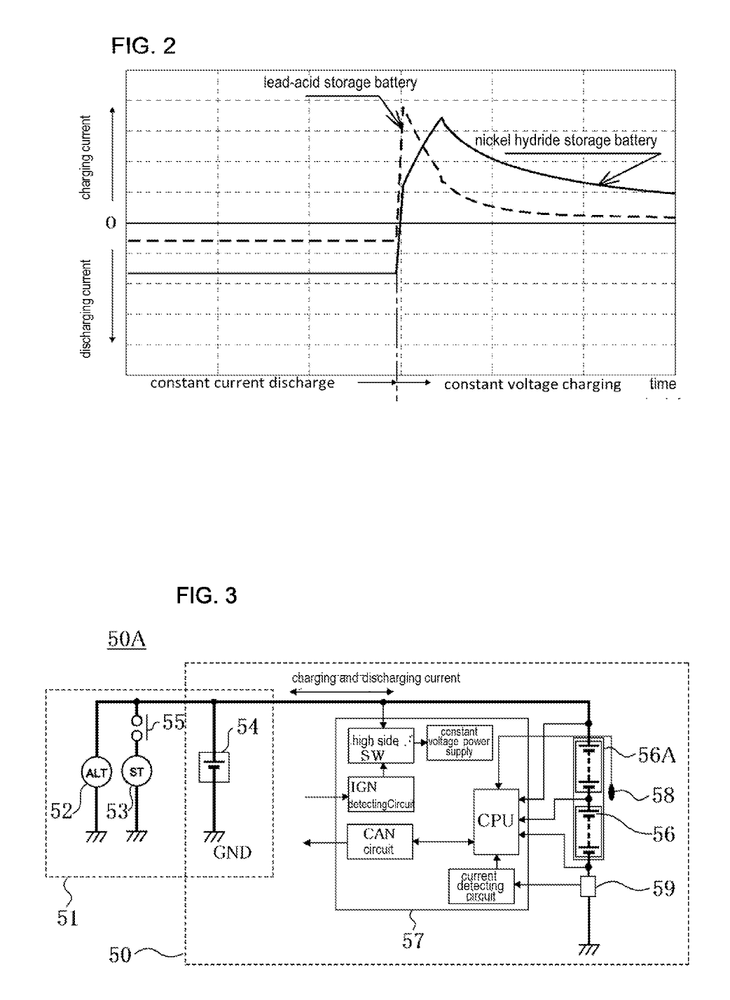

In the storage battery system where the lead-acid storage battery and the nickel hydride storage battery are connected in parallel, general changes of charging and discharging currents at the time of changing from a constant current discharging to a constant voltage charging are shown in FIG. 2. From description of FIG. 2, the following is understood. Namely, at both charging and discharging, charging current and discharging current flow to both storage batteries. However, at discharging, a discharging current of the nickel hydride storage battery is larger than that of the lead-acid storage battery, and at charging, a charging current of the lead-acid storage battery transiently becomes larger than that of the nickel hydride storage battery, but immediately becomes smaller than that of the nickel hydride storage battery. From this, in the storage battery system where the lead-acid storage battery and the nickel hydride storage battery are connected in parallel, since the nickel hydride storage battery as the sub-battery is preferentially charged and discharged at charging and discharging, a discharging load of the lead-acid storage battery as the main battery is decreased, and it is held in a state near a full charge, and it is understood that it is possible that a life of the storage battery system is prolonged.

The lead-acid storage battery in itself (reference example) and the storage battery systems of the experimental examples 1 to 6, respectively were charged with a constant voltage of 14 V for 60 seconds in a constant temperature oven at 60° C., and then were discharged with a constant current of 45 A for 59 seconds, and then were discharged with a constant current of 300 A for 1 second. After this charging and discharging procedure were repeated 3600 times, these were left for 2 days. This durability test was repeated.

When the voltage of the storage battery system becomes less than 7.2 V after the discharging with 300 A for 1 second in the above, a repeat count number at that time was measured. A ratio of the repeat count number of the storage battery system to the repeat count number of the lead-acid storage battery in itself was obtained as an index. The result is shown in Table 3.

TABLE 3

| | | ΔV1 | ΔV2 | |
|---|---|---|---|---|
| title | configuration | (V/day) | (V/day) | X |
| Ref. Ex | lead-acid battery | 0.055 | — | 100 |
| experimental Ex1 | lead-acid battery + | 0.055 | 0.107 | 80 |
| | battery module A | | | |
| experimental Ex2 | lead-acid battery + | 0.055 | 0.036 | 194 |
| | battery module B | | | |
| experimental Ex3 | lead-acid battery + | 0.055 | 0.029 | 280 |
| | battery module C | | | |
| experimental Ex4 | lead-acid battery + | 0.055 | 0.021 | 325 |
| | battery module D | | | |
| experimental Ex5 | lead-acid battery + | 0.055 | 0.013 | 365 |
| | battery module E | | | |
| experimental Ex6 | lead-acid battery + | 0.055 | 0.009 | 405 |
| | battery module F | | | |

According to the above result, the experimental example 1 in which the lead-acid storage battery and the storage battery module A having a relation of ΔV1<ΔV2, had lower durability than that of the lead-acid storage battery by itself. It is thought that as the nickel hydride storage battery has a large self-discharge, a charging current flows from the lead-acid storage battery to the storage battery module A, and then SOC of the lead-acid storage battery is decreased.

The experimental examples 2 to 6 in which the lead-acid storage battery and the storage battery module B to F having a relation of ΔV1≧ΔV2, had much higher durability than that of the lead-acid storage battery by itself. It is thought that as the nickel hydride storage battery has a self-discharge equal to or less than that of the lead-acid storage battery, SOC of the lead-acid storage battery is held high, and the nickel hydride storage battery reduces work amount of the lead-acid storage battery, and then the durability of the storage battery system is more improved than that of the lead-acid storage battery by itself.

Here, when the above relation is satisfied, the electrolyte includes LiOH. In the experimental example 3 to 6 having the lead-acid storage battery and the storage battery modules C to F in which tungsten amount in the electrolyte from 20 mg (the storage battery module C) to 50 mg (the storage battery modules D to F) is contained, and sodium hydroxide concentration in the electrolyte from 1.0 mol/L (the storage battery module E) to 4.0 mol/L (the storage battery module F) is contained, the durability is more improved. It is thought that the sodium hydroxide and tungsten in the electrolyte can suppress a decrease of charging efficiency, and from this the durability of the nickel hydride storage battery is improved, and then work amount of the lead-acid storage battery can be reduced.

Here, in the storage battery modules C to F, sodium tungstate as tungsten source was added in the electrolyte as one example. However, tungsten aqueous oxyate of such as potassium tungstate or lithium tungstate, or tungsten oxide can be also used in the same way. Besides tungstate, addition of niobium compound or molybdenum compound also has the same effect. In this case, niobium aqueous oxyate or oxide, or molybdenum aqueous oxyate can be added. From these, it is understood that preferably a mass of at least one type of compound selected from a tungsten compound, a molybdenum compound, and a niobium compound which the electrolyte contains, is 20 mg or more per the alkaline electrolyte 1 g, and 50 mg or less per the alkaline electrolyte 1 g.

In the above experimental examples, the hydrogen storage alloy having a composition of La_{0.4}Nd_{0.5}Mg_{0.1}Ni_{3.5}Al_{0.2} as the negative electrode active material is used in the nickel hydride storage battery, but other composition of the hydrogen storage alloy can be used. For example, the hydrogen storage alloy is expressed by general formula LaₓRe_{y}Mg_{1-x-y}Niₙ₋ₐMₐ (Re being at least one type of element selected from rare earth elements (excluding La): such as Nd, Sm, or Y, and M being at least one type of element selected from elements of Al and Zn).

In the above experimental examples, the nickel hydride storage battery as the sub-battery was used, but other secondary batteries, such as a lithium ion secondary battery, can be used as the sub-battery in the storage battery system of the present invention. However, products of the lead-acid storage batteries for a vehicle of the nominal voltages 6 V (3 series connection), 12 V (6 series connection), and 24 V (12 series connection) are widely used. In contrast, products of the nickel hydride storage batteries or the lithium ion secondary batteries having the same nominal voltages as the lead-acid storage batteries are used a little. However, as each cell of the nickel hydride storage battery has the nominal voltage 1.2 V, 5 series connection of the cells in the nickel hydride storage battery has the nominal voltage 6 V, and 10 series connection of the cells has the nominal voltage 12 V, and 20 series connection of the cells has the nominal voltage 24 V. Therefore, the nickel hydride storage battery can easily get the same nominal voltage as the lead-acid storage battery.

Here, as shown in FIG. 3, an conventional in-vehicle power supply system portion 51 has a configuration that an alternator 52, a starter 53, and a lead-acid storage battery 54 are connected in parallel, properly through a switch 55. The starter 53 operates as a motor which drives an engine (not shown in the figure) at the initial starting, or at the restarting by turning on the switch 55 from a state of an idle stop, and driving power is supplied from discharging of the lead-acid storage battery 54 at this time. The alternator 12 operates as a generator at the time of engine driving or engine brake function, and the lead-acid storage battery 54 is charged with a regenerative energy at this time.

In the storage battery system 50 related to one embodiment of the present invention, the lead-acid storage battery 54 in the above in-vehicle power supply system portion 51 is connected in parallel to the storage battery module 56A as the sub-battery in which the plural cells of the nickel hydride storage battery 56 are connected in series. Namely, the storage battery system 50 including the alternator 52, the starter 53, the lead-acid storage battery 54, and the storage battery module 56A, configures a new in-vehicle power supply system 50A. In this case, in the storage battery module 56A, a controlling circuit 57, a temperature measurement device 58 such as a thermistor for measuring a temperature of the nickel hydride storage battery 56, and a shunt resistance 59 for measuring a current flowing through the storage battery module 56A are properly connected.

Here, in FIG. 3, two of 5 cell series-connected modules are connected in series as the storage battery module 56A. However, the nickel hydride storage battery 56 may have 10 cell series-connected module, and its connection style is not limited to a specific one. Further, in the case where a large capacity of the sub-battery is necessary, two of 5 cell series-connected modules may be connected in series as the storage battery module 56A, or a plurality of 10 cell series-connected modules may be connected in parallel.

According to the in-vehicle power supply system 50A using this storage battery system 50, at the time of power supply to auxiliary machinery, a discharging current of the nickel hydride storage battery 56 becomes larger than that of the lead-acid storage battery 54. At the time of charging by regenerative energy, a charging current of the lead-acid storage battery 54 transiently becomes larger than that of the nickel hydride storage battery 54, but immediately becomes smaller than that of the nickel hydride storage battery 54. From this, in the storage battery system 50 where the lead-acid storage battery 54 and the nickel hydride storage battery 56 are connected in parallel, since the nickel hydride storage battery 56 as the sub-battery is preferentially charged and discharged at charging and discharging, a discharging load of the lead-acid storage battery 54 as the main battery is decreased, and it is possible that a life of the storage battery system 50 is prolonged.

### REFERENCE MARKS IN THE DRAWINGS

10: nickel hydride storage battery
11: nickel positive electrode
12: hydrogen storage alloy negative electrode
13: separator
14: spiral electrode assembly
15: positive electrode core substrate
16: porous nickel sintered body
17: positive electrode active material
18: negative electrode core substrate
19: negative electrode mixture layer
20: negative electrode current collector
21: positive electrode current collector
22: metal outer can
23: sealing member
24: gasket
25: opening portion
26: valve element
27: positive electrode cap
28: spring member
50: storage battery system
50A: in-vehicle power supply system
51: conventional in-vehicle power supply system portion
52: alternator
53: starter
54: lead-acid storage battery
55: switch
56: nickel hydride storage battery
56A: storage battery module
57: controlling circuit
58: temperature measurement device
59: shunt resistance

1. A storage battery system comprising:
a lead-acid storage battery; and
a sub-battery connected to the lead-acid storage battery in parallel,
wherein from the same temperature and the same voltage as both batteries, a decrease per day of an open-circuit voltage of the lead-acid storage battery by a self-discharge is ΔV1(V/day) and a decrease per day of an open-circuit voltage of the sub-battery by a self-discharge is ΔV2(V/day), and a relation of ΔV1≧ΔV2 is satisfied.

2. The storage battery system according to claim 1,
wherein the sub-battery is a nickel hydride storage battery.

3. The storage battery system according to claim 2,
wherein in the nickel hydride storage battery, a mass of the at least one type of compound selected from a tungsten compound, a molybdenum compound, and a niobium compound which the electrolyte contains, is 20 mg or more per the electrolyte 1 g, and 50 mg or less per the electrolyte 1 g.

4. The storage battery system according to claim 2,
wherein in the nickel hydride storage battery, sodium hydroxide which the electrolyte contains, is 1.0 mol/L or more, and 4.0 mol/L or less.

5. The storage battery system according to claim 3,
wherein in the nickel hydride storage battery, sodium hydroxide which the electrolyte contains, is 1.0 mol/L or more, and 4.0 mol/L or less.
